(19) United States
(12) Patent Application Publication
(10) Pub. No.: US 2002/0170509 A1
(43) Pub. Date: Nov. 21, 2002

(54) Outboard motor including water-cooled V-engine

(76) Inventor: Makoto Yonezawa, Wako-shi (JP)

Correspondence Address: ADAMS & WILKS, 50 Broadway, 31st Floor, New York, NY, 10004, US

(21) Appl. No.: 10/145,048

(22) Filed: May 14, 2002

(30) Foreign Application Priority Data
May 15, 2001 (JP) 2001-144546

(51) Int. Cl. F02F 1/10

(52) U.S. Cl. 123/41.72; 123/195 P

(57) ABSTRACT

An outboard motor includes a water-cooled V-engine. The engine includes right and left cylinder block portions each having plural cylinders formed therein. The cylinders of each cylinder block portion are vertically juxtaposed. Cylinder heads are disposed behind the cylinder block portions. The outboard motor has horizontal and vertical shafts. The outboard motor can tilt up on the horizontal shaft and pivot sideways on the vertical shaft. The cylinders of each cylinder block portion have a cooling jacket formed therein. The lowermost cylinder has a discharge portion formed at an outermost part thereof. The discharge portion is designed to discharge out cooling water remaining in the cooling jacket.

### FIELD OF THE INVENTION

The present invention relates generally to an outboard motor including a water-cooled V-engine having cooling water jackets formed therein, and in particular to the engine designed such that cooling water such as sea water remaining in the cooling water jackets is readily discharged out of the outboard motor when the outboard motor is tilted up and pivoted either rightward or leftward.

### BACKGROUND OF THE INVENTION

Outboard motors having water-cooled engines are well known in the art and attached to sterns of boats. The outboard motors may be tilted up out of water for the purpose of maintenance. At this time, cooling water such as sea water remaining in cooling water jackets formed in the engines should be discharged out so as to prevent corrosion or rusting of the engines.

Japanese Utility Model Laid-Open Publication No. SHO 63-158530 discloses an outboard motor including an engine having cooling water jackets formed therein. When the outboard motor is tilted up and pivoted sideways, the cooling water jackets discharge out unwanted cooling water, which remains therein, through a discharge port formed at an underside of a lowermost cylinder of the engine.

Because the engine is an in-line engine having cylinders provided in vertical juxtaposition, the remaining cooling water can be discharged out of the outboard motor.

Engines for use in the outboard motors include a water-cooled V-engine having two sets or rows of vertically juxtaposed plural cylinders provided at right and left sides thereof. Each set of the cylinders is spaced a predetermined angle (a first angle) away from a central longitudinal axis of a boat. If the outboard motor employing such a V-engine is tilted up and pivoted rightward (or otherwise leftward) by a second angle, the set of the cylinders provided at the right side (or otherwise the left side) of the engine is spaced away from the axis of the boat by angles obtained by adding up the second angle to the first angle. As a result, cooling water within the cooling water jackets would not be satisfactorily discharged out of the discharge port formed in the lowermost cylinder.

### SUMMARY OF THE INVENTION

An object of the present invention is to provide an outboard motor including a V-engine designed to smoothly discharge out cooling water remaining therein when the outboard motor is tilted up and pivoted sideways.

According to one aspect of the present invention, there is provided an outboard motor including a water-cooled V-engine, a horizontal shaft, and a vertical shaft, the outboard motor being tiltable up on the horizontal shaft and pivotable sideways on the vertical shaft, the water-cooled V-engine comprising: right and left cylinder block portions each having plural cylinders formed therein, the cylinders being vertically juxtaposed; cylinder heads disposed behind the right and left cylinder block portions, respectively; the plural cylinders of each of the right and left cylinder block portions having a cooling jacket formed therein, the cooling jacket allowing cooling water to flow therethrough to thereby cool the plural cylinders; and the right and left cylinder block portions having discharge portions formed at the lowermost cylinders thereof, the discharge portions each communicating with the cooling jacket of the plural cylinders of each of the right and left cylinder block portions, the discharge portions each being provided for discharging out cooling water remaining in the cooling jacket.

In the illustrated embodiment as described hereinafter, the lowermost cylinders have the discharge portions positioned at the same level as centers thereof. Therefore, when the outboard motor is tilted up and pivoted sideways for the purpose of maintenance, the cooling water remaining in the cooling jackets is smoothly discharged out through the discharge portions. It thus becomes possible to advantageously protect the engine of the outboard motor against corrosion or rusting.

By thus providing the cylinders with only the discharge portions, the drainage of the cooling water remaining in the cooling jackets can be achieved. The discharge portions may be piped.

In a preferred form of the present invention, the cooling jackets of the right and left cylinder block portions include inside bottom portions inclined forwardly of the outboard motor, the inside bottom portions each being continuous with the discharge portion, such that the cooling water remaining in the cooling jackets is directed along the inside bottom portions into the discharge portions when the outboard motor is tilted up.

The inside bottom portions are continuous with the discharge portions. The inside bottom portions are inclined forwardly of the outboard motor. When the outboard motor is tilted up for the purpose of maintenance, the cooling water remaining within the cooling jackets is directed along the inside bottom portions into the discharge portions. The cooling water is then drained out of the discharge portions.

Preferably, the cooling water discharged from the discharge portions is discharged out of the outboard motor through a cooling water supplying pipe for supplying cooling water to the cooling jackets.

### BRIEF DESCRIPTION OF THE DRAWINGS

Certain preferred embodiments of the present invention will hereinafter be described in detail, by way of example only, with reference to the accompanying drawings, in which:

FIG. 1 is a side elevation view of an outboard motor of the present invention attached to a stern;

FIG. 2 is a view of the outboard motor as viewed in a direction designated 2;

FIG. 3 is a view illustrating an upper part of the outboard motor, an engine cover being shown in vertical cross-section to reveal inner components such as an engine of the outboard motor;

FIG. 4 is a cross-sectional view taken along line 4-4 of FIG. 4 with an intake muffler and an intake manifold of the engine omitted for the purpose of illustrating the engine;

FIG. 5 is a view illustrating, in cross-section, lowermost cylinders of the engine;

FIG. 6 is a cross-sectional view taken along line 6-6 of FIG. 5; and

FIG. 7 is a view schematically illustrating how cooling water flows within cooling water jackets formed in the engine;

### DETAILED DESCRIPTION OF THE PREFERRED EMBODIMENTS

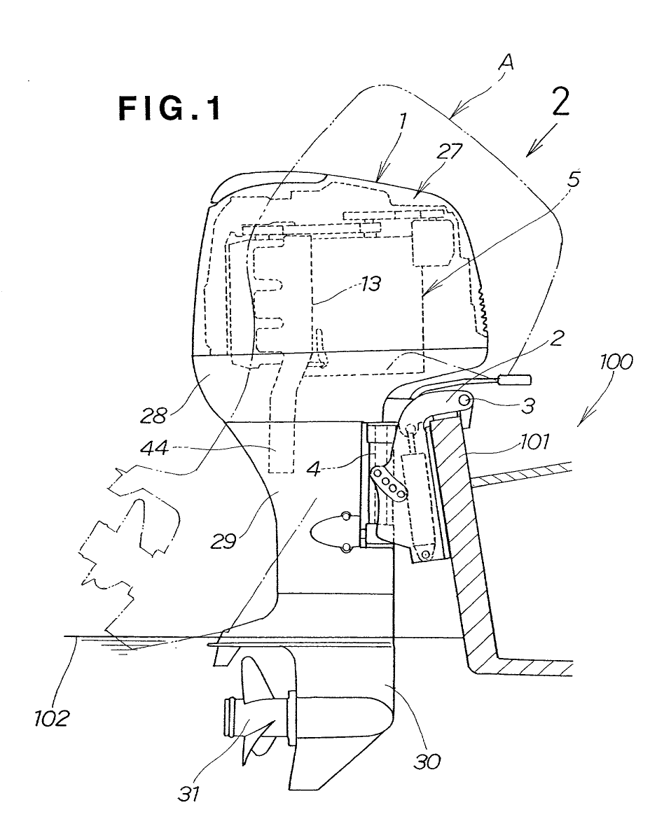

Referring now to FIG. 1, an outboard motor 1 includes an engine cover 27. A stern bracket 2 is positioned at a front part of the outboard motor 1. More specifically, the stern bracket 2 is disposed below the engine cover 27. The outboard motor 1 is detachably mounted via the stern bracket 2 to a stern 101 of a boat 100.

The outboard motor 1 includes a horizontal shaft 3. The outboard motor 1 mounted to the stern 101 is free to tilt or pivot up on the horizontal shaft 3. The outboard motor 1, when tilted up, is shown by a double-dot-and-dash line A of FIG. 1. The outboard motor 1, when tilted up, is exposed to the air with a screw 31 positioned above the surface 102 of water.

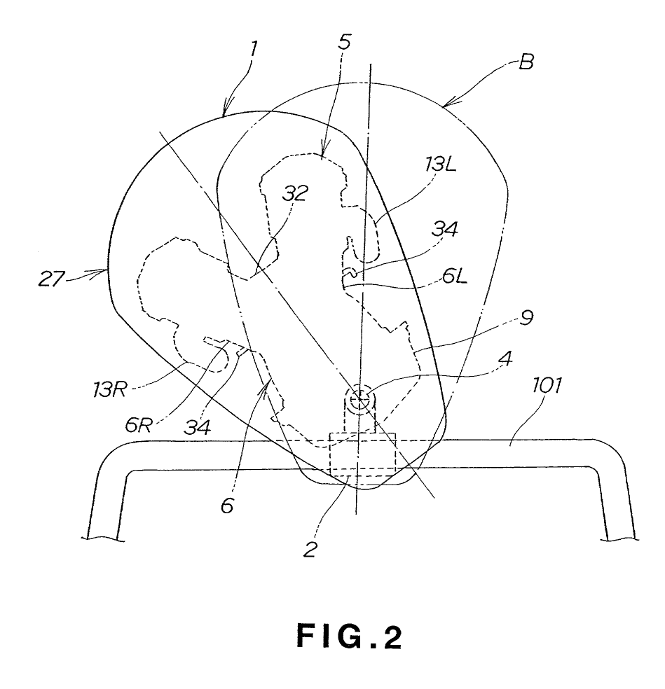

The outboard motor 1 includes a vertical shaft 4. In addition to pivoting up, the outboard motor 1 can pivot sideways on the vertical shaft 4 to thereby turn a boat. As shown by a solid line of FIG. 2, for example, the outboard motor 1 can pivot rightward. The boat can be propelled straight with the outboard motor 1 held in a neutral position as shown by a double-dot-and-dash line B.

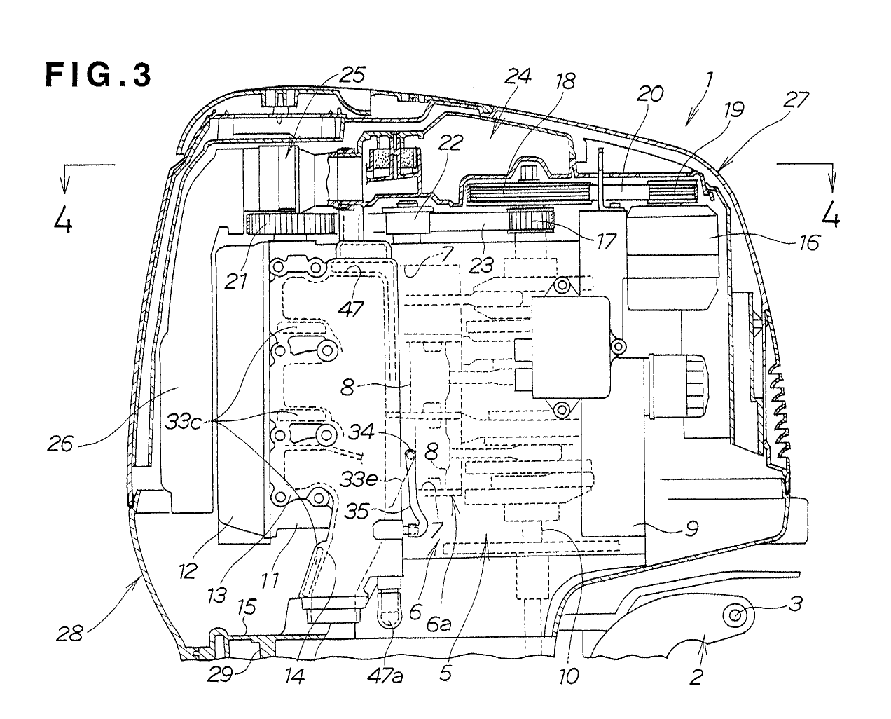

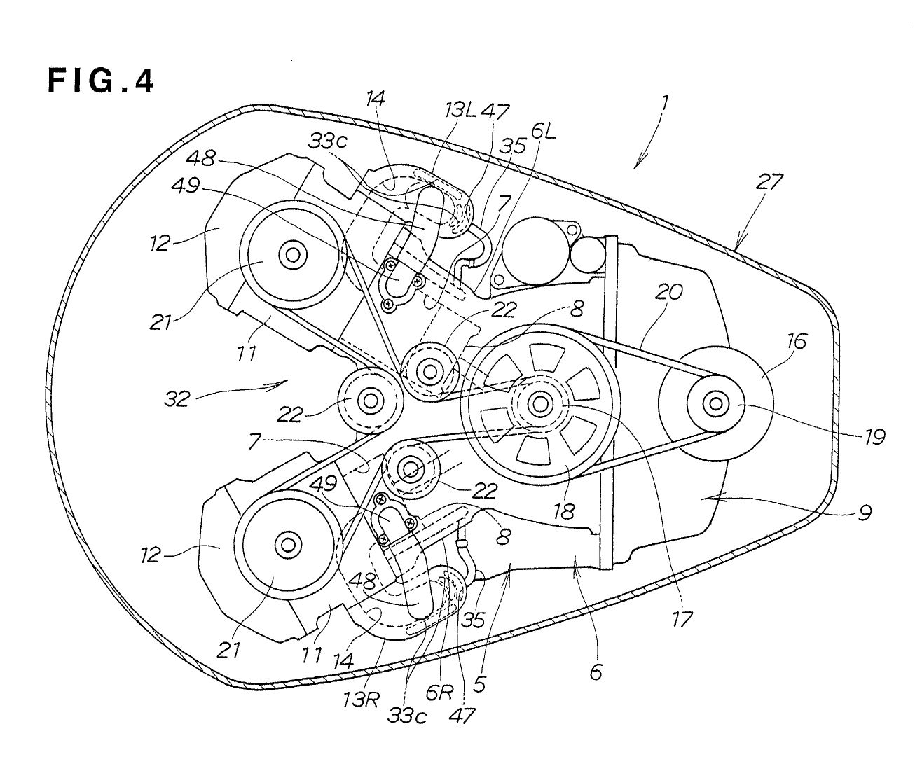

With respect to FIG. 3 and FIG. 4, the outboard motor 1 includes a water-cooled V-six engine 5 having two sets or rows of three cylinders 7 each oriented horizontally.

The three cylinders 7 of each row are vertically disposed side by side. Each cylinder 7 has a piston 8 fitted therein. The engine 5 includes a cylinder block 6 taking the form of V when viewed in plan. A crankcase 9 is disposed at a front side of the cylinder block 6. The respective pistons 8 are connected to a crankshaft 10.

Cylinder heads 11, 11 are disposed behind the cylinder block 6. Cylinder head covers 12, 12 are positioned behind the cylinder heads 11, 11. Exhaust manifolds 13R, 13L are disposed alongside the cylinder heads 11, 11. Each exhaust manifold 13 has an exhaust passageway 14 formed therein. A mount case 15 for supporting the engine 5 is disposed below the cylinder block 6. The mount case 15 has an inside space formed in a rear part thereof. The exhaust passageway 14 communicates with an exhaust pipe 44 through the inside space of the mount case 15, as will be discussed later. An extension case 29 has an exhaust gas expansion chamber 45 formed therein. The respective exhaust pipes 44, 44 extend through such an exhaust gas expansion chamber 45. Exhaust gas flows through the exhaust passageways 14, 14 and the exhaust pipes 44, 44 out of an exit formed at a lower part of the outboard motor 1. Such a lower part of the outboard motor is normally submerged in water.

A generator 16 is disposed at an upper portion of a front part of the engine 5. A first drive pulley 17 is mounted on an upper end of the crankshaft 10. A second drive pulley 18 is also mounted on the upper end of the crankshaft 10. The pulley 18 is positioned above the pulley 17 in coaxial relation thereto. A belt 20 runs over the pulley 18 and a driven pulley 19 of the generator 16. The pulleys 18, 19 and the belt 20 thus arranged are to transmit an output from the engine 5 to the generator 16. When supplied with the output of the engine 5, the generator 16 is energized to produce electricity.

Camshafts have their ends projecting upwardly from the cylinder heads 11, 11. Each camshaft is driven by a camshaft pulley 21. Guide pulleys 22, 22, 22 are disposed near the pulleys 21, 21. A belt 23 runs over the pulleys 17, 21, 21, 22, 22, 22. With this arrangement, the camshafts are driven by the output from the engine 5.

A box-shaped intake muffler (intake silencer) 24 is disposed above these pulleys and belts. The intake muffler 24 has its rear part communicating with an intake passageway formed in a throttle valve device 25. The throttle valve device 25 is connected to an intake manifold 26 disposed behind the cylinder head covers 12, 12.

The engine cover 27 covers the engine 5. An under cover 28 disposed below the engine cover 27 covers the mount case 15. The extension case 29 extends downwardly from the under cover 28. Provided under the extension case 29 is a gear case 30 (FIG. 1). The screw 31 projects rearwardly from the gear case 30. The crankshaft 10 has its lower end connected to a vertical drive shaft. The vertical drive shaft is to transmit the output from the engine 5 to the screw 31. When supplied with the output from the engine 5, the screw 31 is driven.

In FIG. 4, the intake muffler 24 and the intake manifold 26 are not shown for the purpose of explaining the engine 5.

Right and left cylinder block portions (right and left cylinder banks) 6R, 6L of the cylinder block 6 have a space 32 formed therebetween. The exhaust manifolds 13R, 13L are disposed outside the right and left cylinder block portions 6R, 6L, respectively.

Each cylinder 7 has a cylinder bore 7a disposed therewithin. The cylinder head 11 has combustion chambers 11a formed therein.

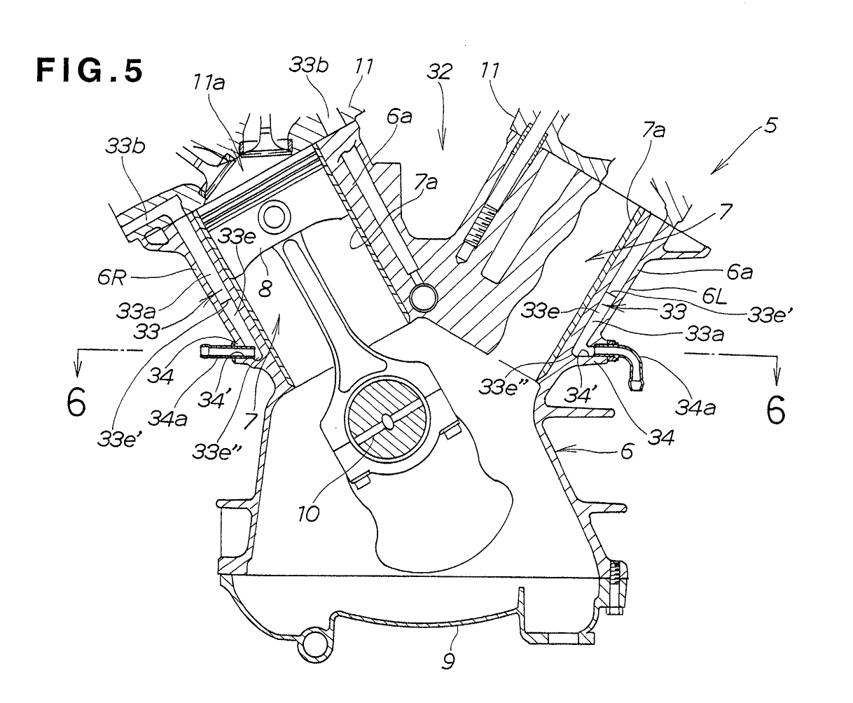

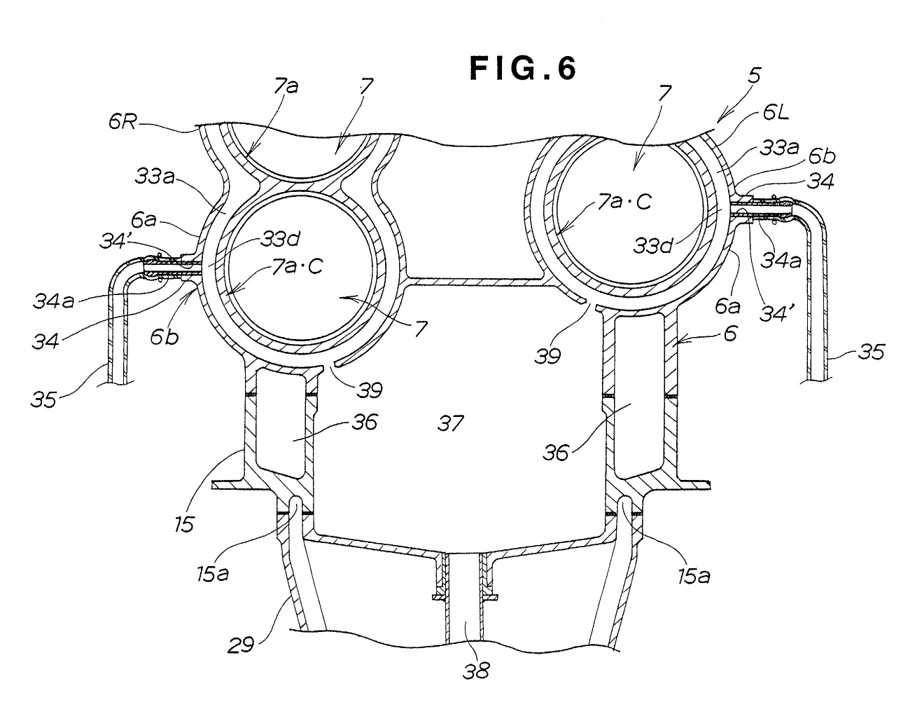

Reference is made to FIG. 5 and FIG. 6. There are shown lowermost cylinders 6a, 6a of the right and left cylinder block portions 6R, 6L. Around the cylinder bores 7a, 7a of the lowermost cylinders 6a, 6a, there are provided cooling water jackets (cooling jackets) 33a, 33a. It should be noted that the cooling water jackets 33a, 33a surround cylinder bores of the uppermost and middle cylinders 7, 7 as well as those of the lowermost cylinders 6a, 6a.

Each cooling water jacket 33a communicates with both a cooling water jacket 33b provided around the combustion chamber 11a and a cooling water jacket 33c provided around the exhaust passageway 14.

Each of the lowermost cylinders 6a, 6a has an outermost part 6b. The outermost part 6b has a discharge portion 34 positioned at the same level as the center C of the cylinder bore 7a of the lowermost cylinder 6a.

The discharge portion 34 is of cylindrical configuration and protrudes outwardly from the outermost part 6b. The discharge portion 34 has a passageway 34′ formed therein. The passageway 34′ of the discharge portion 34 communicates with a water passageway 33d forming in part the cooling water jacket 33a surrounding the cylinder bores. The cylindrical discharge portion 34 has a fitting 34a inserted into the passageway 34′ thereof. The fitting 34a is a pipe and has its outer end connected to a drainage tube 35.

The discharge portions 34, 34 discharge cooling water remaining within the cooling water jackets 33a, 33a when the engine 5 is out of operation, as will be described hereinafter.

Cooling water passages 36, 36 are formed at right and left sides of the mount case 15. The mount case 15 has a cooling water introducing passageway 37 formed therein. The passageway 37 is provided between the passages 36, 36. The passageway 37 communicates with a cooling water supplying pipe 38. Cooling water such as sea water is pumped up through the pipe 38 into the passageway 37. The cooling water within the passageway 37 is then introduced into the cooling water jackets 33a, 33a through introduction ports 39, 39 formed in the outermost parts 6b, 6b.

The drainage tubes 35, 35 communicate with the cooling water jackets 33c, 33c.

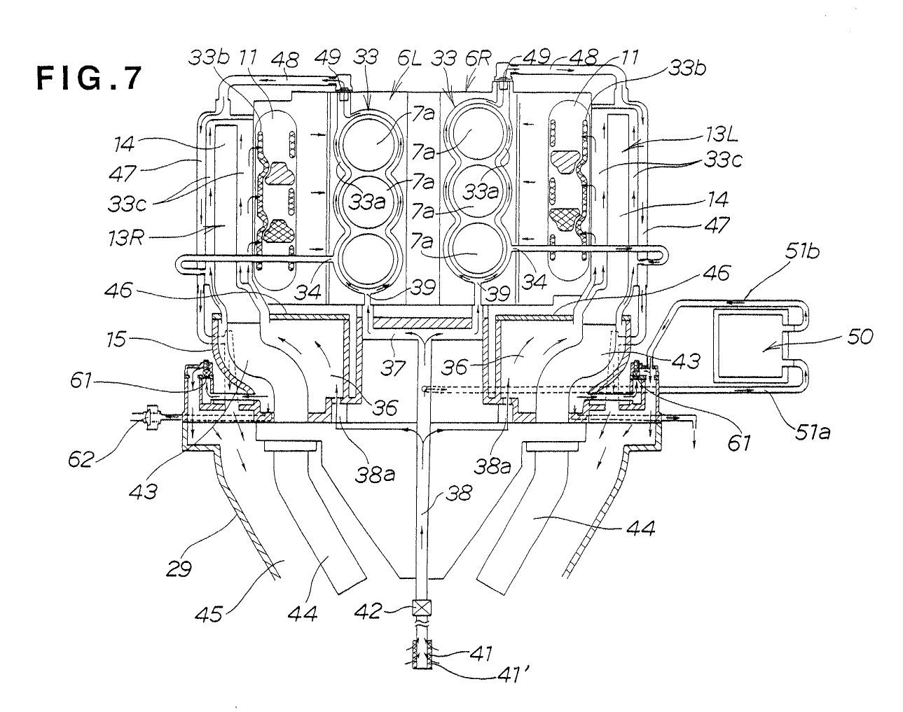

When the engine 5 and a pump 42 (see FIG. 7) become out of operation, cooling water within the water passageways 33d, 33d flows back into the drainage tubes 35, 35 through the cooling water jackets 33c, 33c, the cooling water passages 36, 36 and the cooling water supplying pipe 38 out of an intake port 41 (see FIG. 7).

Discussion will be made as to the flow of cooling water with reference to FIG. 7.

When the pump 41 is actuated, cooling water such as sea water is pumped up through the intake port 41 into the pipe 38, as shown by arrows. The intake port 41 is provided with a strainer 41′. The cooling water is then forced through the introduction ports 39, 39 into the cooling water jackets 33a, 33a to thereby cool the respective cylinder bores of the cylinders of the cylinder block portions 6R, 6L, as shown by arrows.

Part of the pumped cooling water flows through branch passages 38a, 38a and the passages 36, 36 into the cooling water jackets 33c, 33c of the exhaust manifolds 13R, 13L to thereby cool the exhaust passageways 14, 14. The cooling water thus introduced into the cooling water jackets 33a, 33a, 33c, 33c flows into the cooling water jackets 33b, 33b of the cylinder heads 11, 11 to thereby cool the combustion chambers.

The exhaust manifolds 13R, 13L are connected to mount case inside passage members 43, 43. The cooling water passages 36, 36 are provided around the passage members 43, 43, respectively. Each cooling water passage 36 is connected to the branch passage 38a provided upstream of the pipe 38. The part of the cooling water flows through the branch passages 38a, 38a into the cooling water passages 36, 36 to thereby cool the passage members 43, 43.

The mount case inside passage members 43, 43 have their lower ends connected to the exhaust pipes 44, 44, respectively. These pipes 44, 44 extend within the exhaust gas expansion chamber 45. Exhaust gas and the cooling water flow through the pipes 44, 44 and the chamber 45, respectively, out of the outboard motor 1.

Covers 46, 46 are disposed on the mount case 15 in such a manner as to allow the connection of the exhaust manifolds 13R, 13L to the mount case inside passage members 43, 43.

Thermostats 49, 49 are positioned atop the cooling water jackets 33a, 33a of the cylinder block portions 6R, 6L. As shown in FIG. 4, the cooling water jackets 33c and a discharge passage 47 are provided around the exhaust manifold. The cooling water jackets 33a, 33a are connected via connection paths 48, 48 to the discharge passages 47, 47, as shown in FIG. 7.

The thermostats 49, 49 are opened when temperature of the cooling water within the cooling water jackets 33a, 33a exceeds a given value. With the thermostats 49, 49 opened, the cooling water flows through the connection paths 48, 48 into the discharge passages 47, 47. The cooling water in the discharge passages 47, 47 is then discharged into the chamber 45. The discharge passages 47, 47 have their exits 47a, 47a communicating with discharge apertures 15a, 15a. These apertures 15a, 15a are in communication with the exhaust gas expansion chamber 45.

Referring back to FIG. 3 and FIG. 5, the cooling water jackets 33a, 33a of the cylinder block portions 6R, 6L each include an inside wall (an inside bottom portion) 33e continuous with the discharge portion 34. The inside wall 33e is inclined forwardly of the outboard motor 1. The inside wall 33e has its distal and proximal ends 33e′, 33e″. The distal end 33e′ is positioned lower than the proximal end 33e″.

When the outboard motor 1 is tilted up, as shown by the line A, to thereby turn the inside walls 33e, 33e clockwise, the cooling water within the cooling water jackets 33a, 33a is positively or forcibly directed along the inside walls 33e, 33e into the discharge portions 34, 34.

Reference numeral 50 is a cooling jacket for a vapor separator. The cooling water supplying pipe 38 is connected to a cooling pipe 51a. A drainage pipe 51b is provided for discharging cooling water into the exhaust gas expansion chamber 45. Provided at the right and left cooling water passages 36, 36 are water pressure relief valves 61, 61 for adjusting pressure in any water passage through which cooling water pumped by the pump 42 flows prior to reaching the thermostats 49, 49. Each cooling water passage 36 communicates with the chamber 45 through the valve 61. When pressure of cooling water supplied by the pump 42 becomes high, the valves 61, 61 are each opened to thereby allow cooling water within the passages 36, 36 to be drained into the chamber 45. The use of the valves 61, 61 makes it possible to adjust the pressure of the cooling water pumped by the pump 42.

In the illustrated embodiment, sea water is pumped up by the pump 42 to cool the engine 5, therefore, the outboard motor 1 includes a one way valve 62 for cleaning/washing the cooling water jackets. The valve 62 is opened only in cleaning the cooling water jackets. More specifically, when in use, the valve 62 is connected via a hose to an external faucet disposed outside the outboard motor 1. Fresh water is then supplied from the faucet through the hose and the opened valve 62 into the outboard motor 1. The valve 62 is normally closed.

The outboard motor 1 can be tilted or pivoted upwardly on the shaft 3 as shown by the double-dot-and-dash line A of FIG. 1 for the purpose of maintenance. The outboard motor 1 can also be pivoted rightward or otherwise leftward on the shaft 4 for the purpose of maintenance.

With the outboard motor 1 tilted up and pivoted either rightward or leftward, cooling water within the cooling water jackets 33a, 33a needs to be discharged out so as to prevent corrosion or rusting of the engine 5.

In the illustrated embodiment, as stated above, the discharge portions 34, 34 are provided at the same level as the centers C, C of the cylinder bores 7a, 7a of the lowermost cylinders 6a, 6a. When the outboard motor 1 is tilted up and pivoted sideways, either of the discharge portions 34, 34 is lowered. Therefore, cooling water within the cooling water jacket 33a can be discharged out of the outboard motor 1 through the thus lowered discharge portion 34, the cooling water jacket 33c, the cooling water passage 36, and the cooling water supplying pipe 38.

It will be appreciated that even when the outboard motor is tilted up and pivoted sideways for the purpose of maintenance, the cooling water remaining within the cooling water jackets can be smoothly, rapidly discharged out of the outboard motor.

The present disclosure relates to the subject matter of Japanese Patent Application No. 2001-144546, filed May 15, 2001, the disclosure of which is expressly incorporated herein by reference in its entirety.

What is claimed is:

1. An outboard motor including a water-cooled V-engine, a horizontal shaft, and a vertical shaft, said outboard motor being tiltable up on said horizontal shaft and pivotable sideways on said vertical shaft,
said water-cooled V-engine comprising:
right and left cylinder block portions each having plural cylinders formed therein, said cylinders being vertically juxtaposed;
cylinder heads disposed behind said right and left cylinder block portions, respectively;
said plural cylinders of each of said right and left cylinder block portions having a cooling jacket formed therein, the cooling jacket allowing cooling water to flow therethrough to thereby cool said plural cylinders; and
said right and left cylinder block portions having discharge portions formed at the lowermost cylinders thereof, said discharge portions each communicating with said cooling jacket of said plural cylinders of each of said right and left cylinder block portions, said discharge portions each being provided for discharging out cooling water remaining in said cooling jacket.

2. An outboard motor as claimed in claim 1, wherein said cooling jackets of said right and left cylinder block portions include inside bottom portions inclined forwardly of said outboard motor, said inside bottom portions each being continuous with said discharge portion, such that the cooling water remaining in said cooling jackets is directed along said inside bottom portions into said discharge portions when said outboard motor is tilted up.

3. An outboard motor as claimed in claim 1, wherein the cooling water discharged from said discharge portions is discharged out of said outboard motor through a cooling water supplying pipe for supplying cooling water to said cooling jackets.
